(19) United States
(12) Patent Application Publication
(10) Pub. No.: US 2026/0009506 A1
(43) Pub. Date: Jan. 8, 2026

(54) FUEL SUPPLY DEVICE COMPRISING AT LEAST TWO TANKS FOR HYDROGEN IN THE LIQUID STATE AND AT DIFFERENT PRESSURES

(71) Applicant: Airbus Operations SAS, TOULOUSE (FR)

(72) Inventor: Guillaume RAVENEAU, TOULOUSE (FR)

(21) Appl. No.: 19/256,653

(22) Filed: Jul. 1, 2025

(30) Foreign Application Priority Data
Jul. 3, 2024 (FR) FR2407240

(51) Int. Cl. F17C 7/02

(52) U.S. Cl. CPC F17C 7/02; F17C 2201/0109; F17C 2205/0326; F17C 2205/0338; F17C 2205/0352; F17C 2221/012; F17C 2223/0153; F17C 2227/0135; F17C 2227/03; F17C 2265/066; F17C 2270/0189

(57) ABSTRACT

A supply device configured to supply hydrogen to at least one hydrogen system operating at an operating pressure, the supply device including at least one first tank configured to store hydrogen in a liquid state and at a pressure lower than the operating pressure, at least one main line connecting the first tank and the hydrogen system, at least one second tank configured to store hydrogen, in a liquid state and at a pressure higher than the operating pressure, supplying hydrogen to the main line, and at least one pressure regulation system situated in the second tank. An aircraft including at least one such supply device is also provided.

### CROSS-REFERENCES TO RELATED APPLICATIONS

This application claims the benefit of French Patent Application Number FR2407240 filed on Jul. 3, 2024, the entire disclosures of which are incorporated herein by way of reference.

### FIELD OF THE INVENTION

The present application relates to a fuel supply device comprising at least two tanks for hydrogen in the liquid state and at different pressures, and to an aircraft comprising at least one such supply device.

### BACKGROUND OF THE INVENTION

According to one embodiment, a supply device of an aircraft comprises at least one hydrogen tank and at least one distribution circuit connecting the hydrogen tank and at least one hydrogen system that is hydrogen powered, such as a hydrogen engine or a fuel cell.

Each distribution circuit comprises ducts and various items of equipment, such as pumps, sensors, valves or exchangers for example, which are connected to each other by the ducts.

According to a first embodiment, the hydrogen is stored in the hydrogen tank in the liquid state, at a cryogenic temperature, and the distribution circuit comprises a high-pressure pump for pressurizing the hydrogen and a heat exchanger configured to heat the hydrogen, the hydrogen passing from the liquid state to the gaseous state.

Although this first embodiment makes it possible to greatly reduce the volume of the tank compared with a tank storing hydrogen in the gaseous state, it is not entirely satisfactory because the distribution circuit is much more complex and comprises a larger number of items of equipment. Thus, some items of equipment are designed to adapt the quantity of hydrogen provided to the engine(s) according to the desired engine speed while others are designed to double certain items of equipment in the event of a fault so as to obtain a high level of safety.

According to a second embodiment, the hydrogen is stored in a hydrogen tank in the liquid state, at a cryogenic temperature and at a pressure higher than the operating pressure of the hydrogen system.

Although this second embodiment makes it possible to reduce the mass of the tank compared with a tank storing hydrogen in the gaseous state (the tank has to withstand a lower pressure), the tank remains bulky (the density of the hydrogen is lower compared with the first embodiment) and its mass is greater than that of the tank of the first embodiment (the tank has to withstand a higher pressure).

### SUMMARY OF THE INVENTION

The present invention aims to remedy all or some of the drawbacks of the prior art.

To this end, the invention relates to a supply device configured to supply hydrogen to at least one hydrogen system operating at an operating pressure, the supply device comprising:
a. at least one first tank configured to store hydrogen in a liquid state and at a pressure lower than the operating pressure, the first tank having at least one outlet orifice,
b. at least one main line that extends from an upstream end connected to the outlet orifice of the first tank as far as at least one downstream end configured to be connected to a hydrogen system,
c. at least one pump situated on the main line and configured to compress the hydrogen leaving the first tank to a pressure higher than or equal to the operating pressure,
d. at least one main thermal regulation system situated upstream of the downstream end of the main line.

According to the invention, the supply device comprises at least one second tank configured to store hydrogen in a liquid state and at a pressure higher than the operating pressure, this second tank supplying hydrogen to the main line between the pump and the main thermal regulation system.

This solution combines the advantages of the first and second embodiments of the prior art. The first tank makes it possible to obtain a supply like the devices of the prior art storing the hydrogen in the liquid state, and this helps to limit the volume and the mass of the tank for an equivalent quantity of energy. The second tank helps to simplify the supply device. The invention also makes it possible to reduce the number of elements that make up the supply device.

According to another feature, the main line comprises a bifurcation point remote from the upstream and downstream ends, an upstream section that extends between the upstream end of the main line and the bifurcation point and at least one downstream section that extends between the bifurcation point and the downstream end of the main line, the first tank comprising at least one inlet orifice via which hydrogen is introduced into the first tank. In addition, the supply device comprises at least one return line connecting the bifurcation point and the inlet orifice of the first tank and a system for controlling the hydrogen streams in the upstream and downstream sections and in the return line.

According to another feature, the system for controlling the hydrogen streams comprises at least one first valve at the upstream section, at least one second valve at the return line and at least one third valve at the downstream section, each of the first, second and third valves being configured to adjust the flow rate of the hydrogen that passes through it.

According to another feature, the supply device comprises at least one first regulation system situated at the return line. Advantageously, this first regulation system is a thermal regulation system, i.e., configured to regulate a temperature.

According to another feature, the second tank is situated at the return line and comprises at least one outlet orifice connected to the inlet orifice of the first tank and at least one combined orifice connected to the bifurcation point.

According to another feature, the second tank is situated between the bifurcation point and the first regulation system.

According to another feature, the second tank is situated at the downstream section and comprises at least one outlet orifice connected to the downstream end of the main line and at least one inlet orifice connected to the bifurcation point.

According to another feature, the third valve is interposed between the second tank and the bifurcation point, the supply device comprising a fourth valve situated between the second tank and the main thermal regulation system.

According to another feature, the supply device comprises at least one second regulation system situated in the second tank. Advantageously, this second regulation system is a system for regulating a pressure.

According to another feature, the main line comprises a plurality of downstream ends and a plurality of distinct branches, one for each downstream end, each branch having a main thermal regulation system.

The invention also relates to an aircraft comprising at least one supply device according to one of the preceding features and at least one hydrogen system supplied with hydrogen by the supply device.

### BRIEF DESCRIPTION OF THE DRAWINGS

Further features and advantages will become apparent from the following description of the invention, which description is given solely by way of example, with reference to the appended drawings in which:

FIG. 1 is a side view of an aircraft,

FIG. 2 is a schematic depiction of a hydrogen supply device of an aircraft, illustrating a first embodiment of the invention according to a normal operating mode,

FIG. 3 is a schematic depiction of the supply device visible in FIG. 2 according to a mode of operation in the presence of a fault,

FIG. 4 is a schematic depiction of the supply device visible in FIG. 2 according to an operating mode adapted to a taxiing phase,

FIG. 5 is a schematic depiction of the supply device visible in FIG. 2 according to a first operating mode adapted to a take-off phase,

FIG. 6 is a schematic depiction of the supply device visible in FIG. 2 according to a second operating mode adapted to a take-off phase,

FIG. 7 is a schematic depiction of a hydrogen supply device of an aircraft, illustrating a second embodiment of the invention according to a normal operating mode,

FIG. 8 is a schematic depiction of the supply device visible in FIG. 7 according to a mode of operation in the presence of a fault,

FIG. 9 is a schematic depiction of the supply device visible in FIG. 7 according to an operating mode adapted to a taxiing phase,

FIG. 10 is a schematic depiction of the supply device visible in FIG. 7 according to a first operating mode adapted to a take-off phase,

FIG. 11 is a schematic depiction of the supply device visible in FIG. 7 according to a second operating mode adapted to a take-off phase,

FIG. 12 is a schematic depiction of two hydrogen supply devices of an aircraft designed to supply four hydrogen systems.

### DETAILED DESCRIPTION OF THE PREFERRED EMBODIMENTS

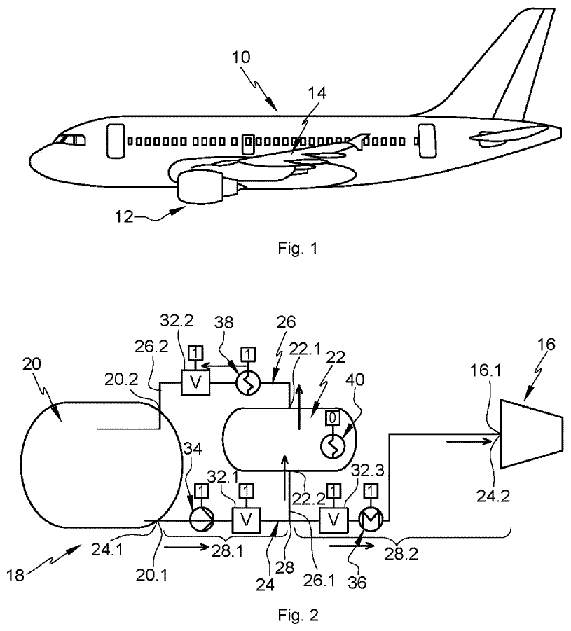

As illustrated in FIG. 1, an aircraft 10 comprises a plurality of propulsion assemblies 12 situated beneath the wings 14 and connected to the latter.

According to one configuration, at least one of the propulsion assemblies 12 comprises an electric motor supplied with electrical energy by at least one fuel cell.

According to another configuration, at least one of the propulsion assemblies 12 comprises a jet engine or a turboprop engine that is hydrogen powered.

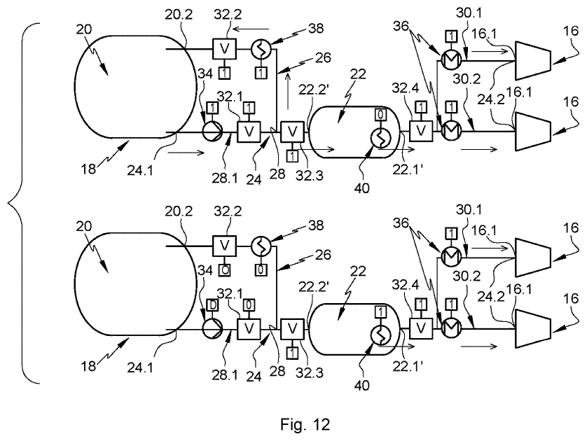

Whatever the embodiment, the aircraft 10 comprises at least one hydrogen system 16 (visible in FIGS. 2 to 12) consuming hydrogen and at least one hydrogen supply device 18 configured to supply the hydrogen system(s) 16. According to an embodiment visible in FIG. 12, the aircraft comprises two supply devices 18 each connected to two hydrogen systems 16.

Each hydrogen system 16 comprises at least one intake 16.1 and operates at a given operating pressure.

The supply device 18 comprises at least one first tank 20 configured to store hydrogen in the liquid state and at low pressure and at least one second tank 22 configured to store hydrogen in the liquid state and at a medium pressure.

Low pressure is understood to mean a pressure of between 1 and 6 bars, preferably of the order of 4 bars.

Medium pressure is understood to mean a pressure higher than the low pressure and higher than or equal to the operating pressure of the hydrogen system(s). The medium pressure is between 6 and 10 bars, preferably equal to approximately 8 bars.

In the first and second tanks 20, 22, the hydrogen is stored at a cryogenic temperature of the order of −253° C. The fact that the hydrogen is stored in the liquid state makes it possible to reduce the dimensions of each of the first and second tanks 20, 22, and this helps to reduce the on-board mass.

The first and second tanks 20, 22 are thermally insulated so as to reduce the losses. These first and second tanks 20, 22 are not described further since they may be identical to the tanks of the prior art configured to store liquefied hydrogen.

According to one embodiment, the first tank 20 comprises at least one outlet orifice 20.1 via which the hydrogen in the liquid state leaves. According to one configuration, the first tank 20 comprises at least one inlet orifice 20.2 via which hydrogen is introduced into the first tank 20.

The supply device 18 comprises a main line 24 connecting the first tank 20 and at least one hydrogen system 16. According to one embodiment, the main line 24 comprises an upstream end 24.1 connected to the outlet orifice 20.1 of the first tank 20 and a downstream end 24.2 connected to the intake 16.1 of the hydrogen system 16.

The supply device 18 comprises at least one return line 26 connecting the first tank 20 and the main line 24 at a bifurcation point 28 remote from the first tank 20 and from the hydrogen system 16. According to one embodiment, the return line 26 comprises a first end 26.1 connected to the bifurcation point 28 and a second end 26.2 connected to the inlet orifice 20.2 of the first tank 20. The main line 24 comprises an upstream section 28.1 that extends between the first tank 20 (or the upstream end 24.1 of the main line 24) and the bifurcation point 28 and at least one downstream section 28.2 that extends between the bifurcation point 28 and the hydrogen system(s) 16 (or the downstream end 24.2 of the main line 24).

According to a configuration visible in FIG. 12, when it supplies a plurality of hydrogen systems 16, the main line 24 comprises a plurality of downstream ends 24.2 and a plurality of distinct branches 30.1, 30.2, one for each downstream end 24.2. Thus, the main line 24 comprises, from upstream to downstream, an upstream section 28.1, a common downstream section 28.2 that extends from the bifurcation point 28 and then one branch 30.1, 30.2 for each hydrogen system 16 connecting the common downstream section 28.2 and the corresponding hydrogen system 16 (or the downstream end 24.2 of the main line 24).

The supply device 18 comprises a system for controlling the hydrogen streams in the upstream and downstream sections 28.1, 28.2 and the return line 26. According to one configuration, the supply device 18 comprises at least one first valve 32.1 at the upstream section 28.1, at least one second valve 32.2 at the return line 26 and at least one third valve 32.3 at the downstream section 28.2. Each of the first, second and third valves 32.1, 32.2, 32.3 is configured to adjust the flow rate of the hydrogen that passes through it.

According to one arrangement, the third valve 32.3 is positioned just downstream of the bifurcation point 28. Thus, no element is interposed between the bifurcation point 28 and the third valve 32.3. According to one arrangement, in the presence of a plurality of hydrogen systems 16, the third valve 32.3 is situated at the common downstream section 28.2 and not at the branches 30.1, 30.2.

According to one embodiment, the supply device 18 comprises at least one pump 34 situated at the upstream section 28.1, just downstream of the outlet orifice 20.1 of the first tank 20. The supply device 18 comprises at least one main thermal regulation system 36, such as a heat exchanger for example, situated at the downstream section 28.2, just upstream of the downstream end 24.2 of the main line 24 or of the intake 16.1 of the hydrogen system 16. According to one arrangement, in the presence of a plurality of hydrogen systems 16, the supply device 18 comprises one main thermal regulation system 36 for each hydrogen system 16, situated at each branch 30.1, 30.2.

According to one configuration, the supply device 18 comprises at least one first thermal regulation system 38, called first regulation system, situated at the return line 26, configured to regulate the temperature of the hydrogen circulating in the return line 26 and reintroduced into the first tank 20. According to one operating mode, the first thermal regulation system 38 is configured to regulate the temperature of the hydrogen circulating in the return line 26 so as to evaporate the liquid hydrogen into gaseous hydrogen at a temperature higher than or equal to the temperature of the hydrogen of the first tank 20 in order to increase the pressure of the hydrogen and so that the first tank 20 is subcooled (which allows correct operation of the pumps). According to one arrangement, the first thermal regulation system 38 is situated between the bifurcation point 28 and the second valve 32.2.

According to one embodiment, the supply device 18 comprises at least one second regulation system 40, called pressure regulation system, situated in the second tank 22 and configured to regulate the pressure of the hydrogen in the second tank 22, in certain operating modes, in order to trigger, by increasing the temperature of the hydrogen (by adding heat), evaporation of at least a part of the liquid hydrogen into gaseous hydrogen in the second tank 22.

The first and second regulation systems 38, 40 may be of electrical or other type.

According to a first embodiment, visible in FIGS. 2 to 6, the first and second tanks 20, 22 are positioned in parallel, the second tank 22 being situated at the return line 26. In this case, the second tank 22 comprises at least one outlet orifice 22.1 connected to the inlet orifice 20.2 of the first tank 20 and at least one combined orifice 22.2, ensuring the exit or entry of the hydrogen into the second tank 22, connected to the bifurcation point 28. According to one arrangement, the second tank 22 is situated between the bifurcation point 28 and the first thermal regulation system 38.

According to an operating mode referred to as normal illustrated in FIG. 2, in the flight phase and in the absence of fault(s), the hydrogen leaves the first tank 20 at low pressure. As soon as it leaves, the hydrogen passes through the pump 34 so as to be compressed and reach a higher pressure adapted to the hydrogen system(s) 16 and to the second tank 22. At the bifurcation point 28, a first part of the hydrogen leaving the pump 34 is introduced into the second tank 22 and a second part of the hydrogen is transmitted to the hydrogen system(s) 16.

The second regulation system 40 is not necessarily activated. It makes it possible, if necessary, to heat the hydrogen present in the second tank 22 and to regulate its pressure inside this second tank 22. The pressure of the hydrogen present in the second tank 22 can also be regulated by adjusting the quantity of hydrogen entering the second tank 22 by virtue of the first and third valves 32.1, 32.3 and the quantity of hydrogen leaving the second tank 22 by virtue of the second valve 32.2. According to this normal operating mode, each hydrogen system 16 is only supplied with hydrogen by the first tank 20, the hydrogen leaving the first tank 20 being compressed by the pump 34 to increase its pressure to a pressure higher than or equal to the operating pressure of the hydrogen system(s) 16.

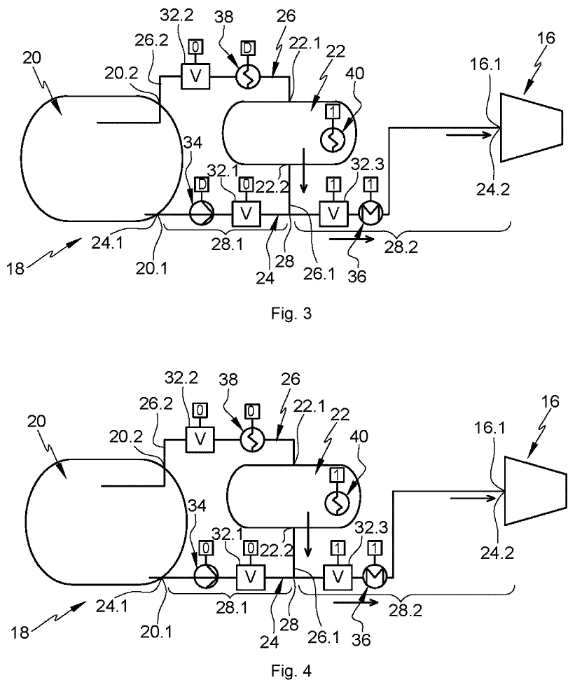

According to a degraded operating mode illustrated in FIG. 3, in the presence of a fault, when at least one element among the pump 34 and the first thermal regulation system 38 is faulty, the first tank 22 is isolated by closing the first and second valves 32.1, 32.2. In this case, the second regulation system 40 can be activated. Since the hydrogen pressure in the second tank 22 is higher than or equal to the operating pressure of the hydrogen system(s) 16, the second tank 22 supplies, without a pump, the hydrogen system(s) 16.

According to an operating mode adapted to a taxiing phase and illustrated in FIG. 4, the first tank 22 is isolated by closing the first and second valves 32.1, 32.2 after landing. In addition, the pump 34 and the first thermal regulation system 38 are stopped. Since the hydrogen pressure in the second tank 22 is higher than or equal to the operating pressure of the hydrogen system(s) 16, the second tank 22 supplies, without a pump, the hydrogen system(s) 16. Thus, the majority of the hydrogen present in the second tank 22 is consumed prior to a phase of refueling on the ground before the next flight. This solution makes it possible to optimize the quantity of hydrogen stored in the first and second tanks 20, 22 for one flight.

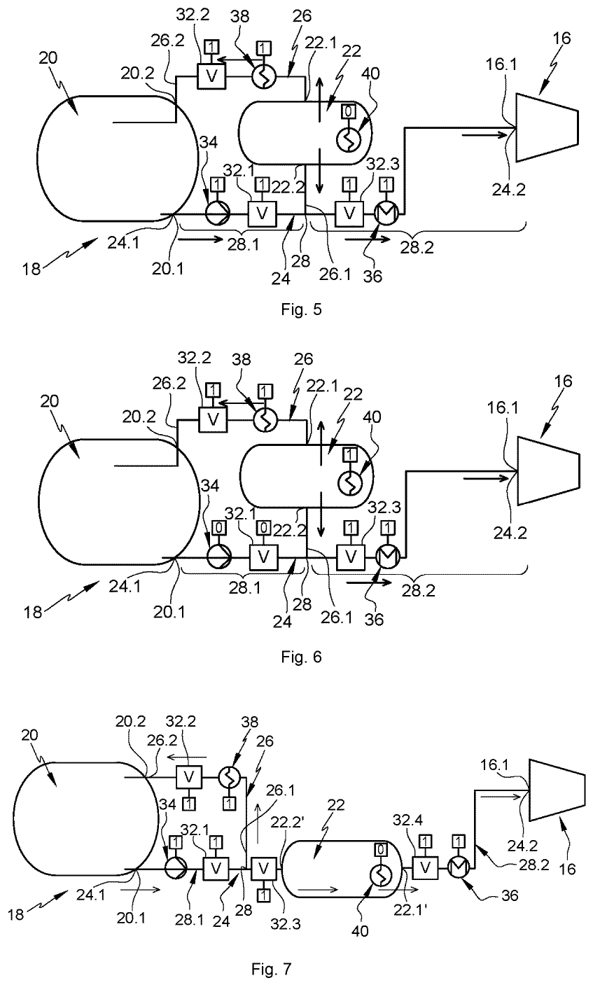

According to a first operating mode adapted to a take-off phase, illustrated in FIG. 5, the hydrogen leaving the first tank 20 is compressed by the pump 34 so as to be at a pressure adapted to the hydrogen system(s) 16 and to the second tank 22, as is the case for the normal operating mode. The hydrogen present in the second tank 22 flows in the direction of the first tank 20 and/or of the hydrogen system(s) 16. The second regulation system 40 may not be activated. According to this first operating mode adapted to a take-off phase, each hydrogen system 16 can be simultaneously supplied with hydrogen by the first and second tanks 20, 22.

According to a second operating mode adapted to a take-off phase, illustrated in FIG. 6, each hydrogen system 16 is supplied with hydrogen only by the second tank 22 and not by the first tank 20. The pump 34 is therefore stopped and the first valve 32.1 is in the closed state. In this case, the second regulation system 40 is activated so as to heat the hydrogen present in the second tank 22.

As illustrated in FIG. 6, the second tank 22 can also be used to supply the first tank 20 by opening the second valve 32.2. This operating mode may be extended until the pressure in the second tank 22 is no longer sufficient to supply the hydrogen system(s) 16.

According to a second embodiment, visible in FIGS. 7 to 12, the first and second tanks 20, 22 are positioned in series, the second tank 22 being situated at the downstream section 28.2, more particularly at the common trunk of the downstream section 28.2 situated upstream of the branches 30.1, 30.2. In this case, the second tank 22 comprises at least one outlet orifice 22.1′ connected to the downstream end 24.2 of the main line 24 and at least one inlet orifice 22.2′ connected to the bifurcation point 28.

According to this second embodiment, the third valve 32.3 is interposed between the second tank 22 and the bifurcation point 28. In addition, the supply device 18 comprises a fourth valve 32.4 situated at the outlet of the second tank 22, more particularly, between the second tank 22 and the main thermal regulation system(s).

According to an operating mode referred to as normal illustrated in FIG. 7, in the flight phase and in the absence of fault(s), the hydrogen leaves the first tank 20 at low pressure. As soon as it leaves, the hydrogen passes through the pump 34 so as to be at a higher pressure adapted to the hydrogen system(s) 16 and to the second tank 22.

The hydrogen leaving the pump 34 supplies, in cascade, the second tank 22, which itself supplies the hydrogen system(s) 16. The second regulation system 40 is not necessarily activated.

Depending on the circumstances, a part of the hydrogen leaving the pump 34 is reintroduced into the first tank 20 via the return line 26 by adjusting the flow rate of the second and third valves 32.2, 32.3.

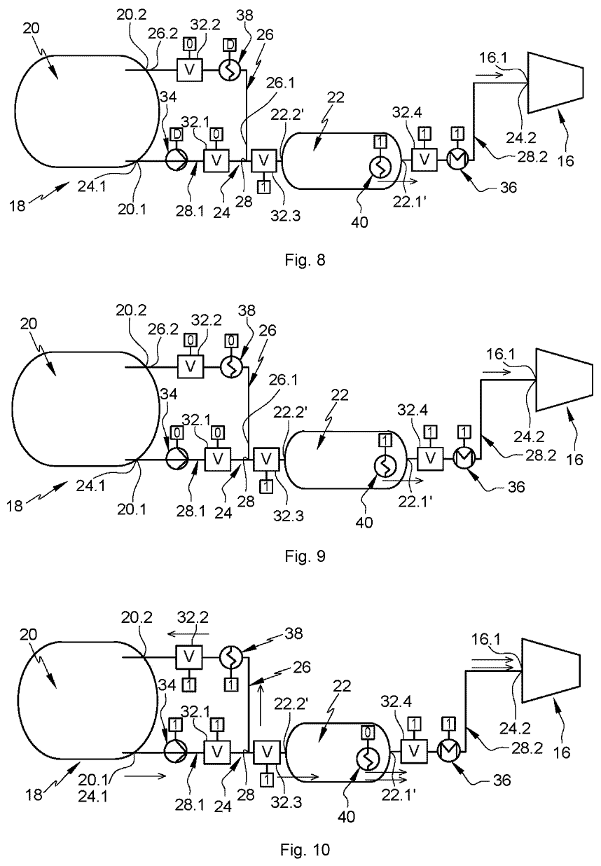

According to a degraded operating mode illustrated in FIG. 8, in the presence of a fault, when at least one element among the pump 34 and the first thermal regulation system 38 is faulty, the first tank 22 is isolated by closing the first and second valves 32.1, 32.2. In this case, the second regulation system 40 is generally activated. Since the hydrogen pressure in the second tank 22 is higher than or equal to the operating pressure of the hydrogen system(s) 16, the second tank 22 supplies, without a pump, the hydrogen system(s) 16.

According to an operating mode adapted to a taxiing phase, illustrated in FIG. 9, the first tank 22 is isolated by closing the first and second valves 32.1, 32.2 after landing. In addition, the pump 34 and the first thermal regulation system 38 are stopped. Since the hydrogen pressure in the second tank 22 is higher than or equal to the operating pressure of the hydrogen system(s) 16, the second tank 22 supplies, without a pump, the hydrogen system(s) 16. Thus, the majority of the hydrogen present in the second tank 22 is consumed prior to a phase of refueling on the ground before the next flight. This solution makes it possible to optimize the quantity of hydrogen stored in the first and second tanks 20, 22 for one flight.

According to a first operating mode adapted to a take-off phase and illustrated in FIG. 10, the hydrogen leaving the first tank 20 is compressed by the pump 34 so as to be at a pressure adapted to the hydrogen system(s) 16 and to the second tank 22, as is the case for the normal operating mode. The hydrogen leaving the pump 34 supplies, in cascade, the second tank 22, which itself supplies the hydrogen system(s) 16. The second regulation system 40 is not necessarily activated.

Depending on the circumstances, a part of the hydrogen leaving the pump 34 is reintroduced into the first tank 20 via the return line 26 by adjusting the flow rate of the second and third valves 32.2, 32.3.

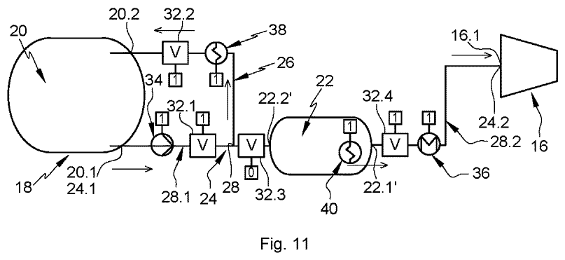

According to a second operating mode adapted to a take-off phase and illustrated in FIG. 11, each hydrogen system 16 is supplied with hydrogen only by the second tank 22 and not by the first tank 20. The latter is isolated from the downstream section 28.1 by closing the third valve 32.3. The first tank 20 may be subcooled by injection of gaseous hydrogen via the pump 34 and the thermal regulation system 38 (independent of the second tank 22 and of the hydrogen system 16).

The hydrogen leaving the first tank 20 is compressed by the pump 34 and then reintroduced into the first tank 20 via the return line 26. The first thermal regulation system 38 can be activated and the first and second valves 32.2 are in the open state.

In this case, the second regulation system 40 is activated so as to heat the hydrogen present in the second tank 22. The operating mode may be extended until the pressure in the second tank 22 is no longer sufficient to supply the hydrogen system(s) 16.

Whatever the embodiment, a supply device 18 configured to supply hydrogen to at least one hydrogen system 16 operating at an operating pressure comprises:
a. at least one first tank 20 configured to store hydrogen in the liquid state and at a pressure lower than the operating pressure, the first tank 20 having at least one outlet orifice 20.1,
b. at least one main line 24 that extends from an upstream end 24.1 connected to the outlet orifice 20.1 of the first tank 20 as far as at least one downstream end 24.2 configured to be connected to the hydrogen system 16,
c. at least one pump 34 situated on the main line 24 and configured to compress the hydrogen leaving the first tank 20 to a pressure higher than or equal to the operating pressure,
d. at least one main thermal regulation system 36 situated upstream of the downstream end 24.2 of the main line 24,
e. at least one second tank 22 configured to store hydrogen, in the liquid state and at a pressure higher than the operating pressure, supplying hydrogen to the main line between the pump 34 and the main thermal regulation system 36.

This solution combines the advantages of the first and second embodiments of the prior art. The first tank 20 makes it possible to obtain a supply like the devices of the prior art storing the hydrogen in the liquid state, and this helps to limit the volume and the mass of the tank for an equivalent quantity of energy. The second tank 22 makes it possible to obtain a supply like the device of the second embodiment of the prior art storing the hydrogen in the liquid state and with a pressure higher than the operating pressure, and this helps to simplify the supply device.

The invention makes it possible to reduce the number of elements, some of them providing a redundancy function but also a function of modulating the quantity of hydrogen provided, and this helps to simplify the supply device while at the same time maintaining a high level of safety. Thus, the second tank 22 makes it possible to double the first tank 20 in the event of malfunction of the latter and/or of the pump 34 but also to participate in the regulation of the quantity of hydrogen transmitted to the hydrogen system(s) 16 during specific phases of the flight such as the take-off and taxiing phases.

According to a preferred embodiment, the supply device 18 comprises a return line 26 allowing a part of the hydrogen leaving the first tank 20 to be reintroduced into the first tank, and this helps to simplify the regulation of the quantity of hydrogen transmitted to each hydrogen system 16, more particularly of the quantity of hydrogen leaving the first tank 20 and passing through the pump 34, which can then be substantially constant.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A supply device configured to supply hydrogen to at least one hydrogen system operating at an operating pressure, said supply device comprising:
at least one first tank configured to store hydrogen in a liquid state and at a pressure lower than the operating pressure, said first tank having at least one outlet orifice,
at least one main line that extends from an upstream end connected to the outlet orifice of the first tank as far as at least one downstream end configured to be connected to a hydrogen system,
at least one pump situated on the main line and configured to compress the hydrogen leaving the first tank to a pressure higher than or equal to the operating pressure,
at least one main thermal regulation system situated upstream of the at least one downstream end of the main line,
at least one second tank configured to store hydrogen in a liquid state and at a pressure higher than the operating pressure, said second tank supplying hydrogen to the main line between the pump and the main thermal regulation system, and
at least one pressure regulation system situated in the second tank.

2. The supply device according to claim 1,
wherein the main line comprises a bifurcation point remote from the upstream and at least one downstream ends, an upstream section that extends between the upstream end of the main line and the bifurcation point and at least one downstream section that extends between the bifurcation point and the at least one downstream end of the main line,
wherein the first tank comprises at least one inlet orifice via which hydrogen is introduced into the first tank and in that the supply device comprises at least one return line connecting the bifurcation point and the inlet orifice of the first tank and a system for controlling a flow of hydrogen in the upstream and downstream sections and in the return line.

3. The supply device according to claim 2, wherein the system for controlling the flow of hydrogen comprises at least one first valve at the upstream section, at least one second valve at the return line and at least one third valve at the downstream section, each of the first, second and third valves being configured to adjust a flow rate of the hydrogen that passes through such valve.

4. The supply device according to claim 2, wherein the supply device comprises at least one thermal regulation system situated at the return line.

5. The supply device according to claim 2, wherein the second tank is situated at the return line and comprises at least one outlet orifice connected to the inlet orifice of the first tank and at least one combined orifice connected to the bifurcation point.

6. The supply device according to claim 4,
wherein the second tank is situated at the return line and comprises at least one outlet orifice connected to the inlet orifice of the first tank and at least one combined orifice connected to the bifurcation point, and
wherein the second tank is situated between the bifurcation point and the thermal regulation system.

7. The supply device according to claim 2, wherein the second tank is situated at the downstream section and comprises at least one outlet orifice connected to the at least one downstream end of the main line and at least one inlet orifice connected to the bifurcation point.

8. The supply device according to claim 7,
wherein the system for controlling the flow of hydrogen comprises at least one first valve at the upstream section, at least one second valve at the return line and at least one third valve at the downstream section, each of the first, second and third valves being configured to adjust a flow rate of the hydrogen that passes through such valve,
wherein the at least one third valve is interposed between the second tank and the bifurcation point, and
wherein the supply device comprises a fourth valve situated between the second tank and the main thermal regulation system.

9. The supply device according to claim 1, wherein the main line comprises a plurality of downstream ends and a plurality of distinct branches, one for each downstream end, each branch having a main thermal regulation system.

10. An aircraft comprising at least one supply device according to claim 1 and at least one hydrogen system supplied with hydrogen by the supply device.
